(19) United States
(12) Patent Application Publication
(10) Pub. No.: US 2022/0108269 A1
(43) Pub. Date: Apr. 7, 2022

(54) METHOD AND SYSTEM FOR AUTOMATICALLY DISTRIBUTING ASSET POOL SHARES AMONG ACTORS IN A BLOCKCHAIN NETWORK

(71) Applicant: Siemens Aktiengesellschaft, Muenchen (DE)

(72) Inventors: Alastair Orchard, Genua (IT); Corradino Guerrasio, Genua (IT)

(21) Appl. No.: 17/492,877

(22) Filed: Oct. 4, 2021

(30) Foreign Application Priority Data
Oct. 2, 2020 (EP) 20199860.6

(51) Int. Cl. G06Q 10/08; G06F 9/54

(52) U.S. Cl. CPC G06Q 10/0838; G06F 9/54

(57) ABSTRACT

A method for automatically distributing asset pool shares among actors in a supply chain blockchain network includes: receiving measured values of contribution/obtainment parameters and of obtainment parameters of all network actors based on an amount of actor data inflow/outflow to/from the network in a given time interval; determining, for each actor aᵢ, a net asset balance NBⁱ based on a product between an asset pool to be distributed among actors and the difference between a contribution ratio and an obtainment ratio. Asset pool shares are distributed at defined times among the actors by transferring asset amounts directly between actor pairs via a plurality of corresponding blockchain transferal transactions where a first actor receives an amount of assets from a second actor having a higher net balance. The asset amounts are determined according to a predefined distribution rule based on the net asset balances NB¹, NBⁱ, NB^{N} of the N actors.

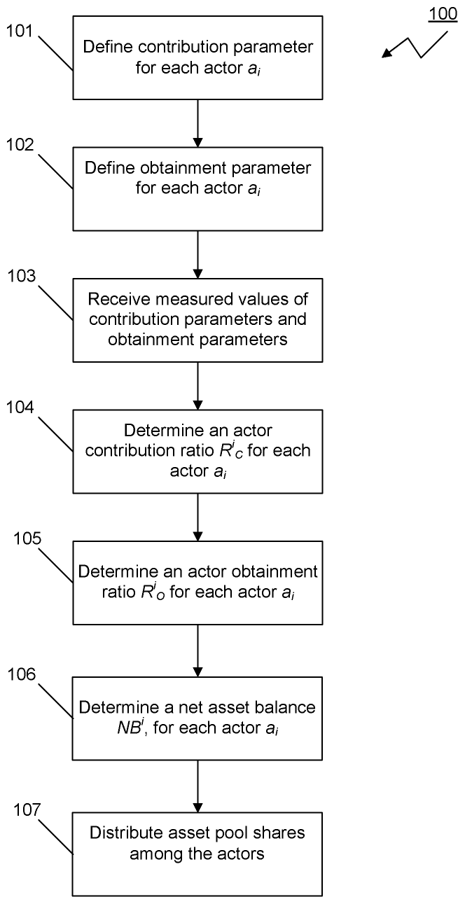

### CROSS-REFERENCE TO RELATED APPLICATION

This application claims the priority, under 35 U.S.C. § 119, of European patent application EP20199860.6, filed Oct. 2, 2020; the prior application is herewith incorporated by reference in its entirety.

### FIELD AND BACKGROUND OF THE INVENTION

The invention relates to a method and a system for automatically distributing asset pool shares among actors in a blockchain network wherein the blockchain network is configured to record transactions of a number of actors of a supply chain. The invention also relates to a corresponding data processing system for automatically distributing asset pool shares among the actors in the blockchain network.

Blockchains are most often used to record transactions between parties according to a smart contract.

In industrial use cases, the transactions which are recorded in a blockchain typically refer to the supply of materials or to the provision of services, for instance, acquiring raw materials, transforming them into finished goods, and distributing the products to customers.

In supply chain management systems, blockchain technologies are used for tracking and tracing of products and items in an automatic, fast and secure manner.

Examples of tracked and traced items include, but are not limited to, final products, raw materials, ingredients, order operations, manufacturing operations, packaging operations, logistics operations, shipping operations, transportation operations and any other relevant product lifecycle operation.

The distributed and secure nature of the blockchain lends itself extremely well to the traceability of products across multiple stakeholders, such as, “from farm to fork.”

Therefore, tracking solutions based on blockchain technologies are widely deployed by many of the largest international manufacturing, retailing and logistics companies.

Assume an exemplary industrial use case of a product value chain comprising three different types of actors, such as, a product brand owner, a farmer company and a logistics provider respectively called actor A, actor B, and actor C.

Typically, actor A holds information on the processing and packaging of goods, actor B holds information on food growing, and actor C holds information on product or material shipping.

Assume actor A is interested to arrange these three different types of actors in a track and trace network based on blockchain technology.

When a blockchain technology is applied for lifecycle traceability purposes, it is mandatory that each actor in the product value chain participates in and contributes to the product traceability. Otherwise, the chain might be broken with a traceability loss.

In the pertinent art, it is known that in such blockchain systems there are asymmetric contributions and gains as regards the values of exchanged resources between the different types of actors; for example, ranging between net benefactors (e.g., actor A types), through neutral users (e.g., actor C types), to net contributors (e.g., actor B types).

Those of skill in the pertinent art are well aware that participation to supply chain blockchain networks imply, for the involved actors, the usage of several means, for example for hardware hosting, for running a blockchain node, for writing network transactions, for participating to the network, for collecting sensor data, and so on. On the other hand, one or more actors, such as, for example, the brand owners, benefit from the participation of the other actors in the network, such as, for example, the farmer companies and the logistics providers.

As used herein the terms “network resource” denotes resource/means allocation for the actors participating in and contributing to the blockchain network. Examples of network resources include, but are not limited to, resource requirements for network participation in terms of hardware, software, time, personnel, data exchange means, data collection means, etcetera.

During a chosen time interval (e.g. each day, week, month, or year), each actor may experience differing levels of benefits as a result of using the network for a unit allocation of network resources. Some actors may enjoy a net gain, others may break even, and a few who might be essential to the proper functioning of the network may suffer persistent losses.

In an exemplary use case, the brand owner may experience 30% of the total benefits generated by the network (e.g., also by performing a complex recall of products from the market), for allocating only 10% of the total network resources. The farmer may allocate 25% of the total resources (e.g., by registering the harvest transactions) without receiving any of the benefits. This asymmetry in the relative effort versus the reward between actors is not stable—with each time interval creating new asymmetries among network actors.

Current blockchain techniques for track and trace do not enable assets to be automatically and efficiently distributed among network actors in order to rebalance asymmetries of actor contributions and gains.

As used herein the term “asset” or “assets” denotes items having a certain recognized value which can be exchanged among actors. Examples of assets may include, but are not limited to, tokens, currencies (digital or real), coins, vouchers, any item of recognized value which can be swapped and exchanged between actors.

Denoted as “service provider” is the party which is typically managing the blockchain network and which is responsible for establishing the consortium and for operating the blockchain service. In the art, service providers may often find themselves brokering the agreements among all the network actors, and potentially handling the redistribution of assets, such as, for example, via service fees.

With a large number of actors, for instance, measured in tens, hundreds or thousands, sometimes even in different countries, a huge volume of network transactions, e.g., measured in millions or billions, and a dynamically shifting symmetry, the overhead for the service providers of such brokerage efforts outweighs the value of their provided services and therefore could, for example, exceed the billing fees that the net benefactors are then willing to pay.

Even in the use case where the service provider and the net benefactor are the same party, it is still desirable to find an efficient technique to enable the net benefactors for automatically compensating the net contributors for their contributions to the network.

Current asset distribution techniques among actors of a blockchain network for track and trace of supply chain operations are a mix of automatic and manual operations and are cumbersome, tedious, error-prone and otherwise ill-suited for the task.

### SUMMARY OF THE INVENTION

It is accordingly an object of the invention to provide a process and system which overcome the above-mentioned disadvantages of the heretofore-known devices and methods of this general type and which provides for a method and system for distributing asset pool shares among actors in a blockchain network in an automatic and balanced manner.

With the above and other objects in view there is provided, in accordance with the invention, a method and a system for automatically distributing asset pool shares among actors in a blockchain network. The blockchain network is configured to record transactions of N actors a₁, aᵢ, a_{N} of a supply chain. The method comprises the following steps:

defining for each actor aᵢ a contribution parameter based on an amount of actor data inflow to the network;

defining for each actor an obtainment parameter based on an amount of actor data outflow out of the network;

receiving measured values of contribution parameters and measured values of obtainment parameters of all the network actors in a given time interval;

for each actor aᵢ, determining an actor contribution ratio Rⁱ_{C} based on a ratio between the own contribution parameter and a sum of all contribution parameters of all N actors;

for each actor aᵢ, determining an actor obtainment ratio Rⁱ_{O} based on a ratio between the own obtainment parameter and a sum of all contribution parameters of all N actors;

determining, for each actor aᵢ, a net asset balance NBᵢ based on a product between an asset pool to be distributed among actors and the difference between the contribution ratio and the obtainment ratio;

at defined time points, distributing asset pool shares among the actors by transferring asset amounts directly between actor pairs through a plurality of corresponding blockchain transferal transactions in which, in at least one transaction, a first actor receives an amount of assets from a second actor having a higher net balance, where asset amounts are determined according to a predefined distribution rule based on the determined net-balances NB₁, NBᵢ, NB_{N} of the N actors.

Herein, “N” is a real number and “i” is an index representing a real number. Both are integers.

In accordance with the invention, the contribution parameter and the obtainment parameter may be obtained by measuring respectively volume of actor write data and volume of actor read data via a corresponding smart contract API having as input the actor's network identifier and the given time interval.

In an exemplary embodiment, the distribution of asset pool shares may be performed by the same blockchain. In another embodiment, the distribution of asset pool shares may be performed by an additional, separate blockchain.

Furthermore, a computer program may be provided, comprising computer program code for performing steps according to the above method when loaded in a digital processor of a computing device.

Additionally, a computer program product stored on a computer usable medium can be provided, comprising non-transitory computer readable program code for causing a computing device to perform the mentioned method.

In certain embodiments, the actor contribution parameter is calculated based on write data volumes by means of a contribution algorithm in a smart contract. With embodiments, the actor contribution parameter may provide an estimate of the actor contribution amount to the network resources.

In embodiments, the actor obtainment parameter is calculated based on read data volumes by means of an obtainment algorithm in a smart contract. The actor obtainment parameter advantageously provides an estimate of the actor obtainment amount from the network resources.

In a preferred embodiment, it is possible to automatically and adaptively determine the amount of assets to be assigned to each network actor. Similarly, the determined shares of assets may be automatically distributed directly among actors in a peer-to-peer and dynamic manner.

It is also possible to automatically assign to blockchain actors their own share of a token pool depending on their contribution to the network resources.

In accordance with an added feature of the invention, a blockchain may be used to manage a fixed subscription between each actor and the service provider.

In accordance with another feature of the invention, a blockchain may be used to ensure that net contributors are compensated by net benefactors without requiring the service provider to act as a middle agent.

In accordance with further features of the invention, the asymmetrical values of resource contributions delivered by the supply-chain actors of the blockchain networks are automatically compensated.

It is possible, in an embodiment of the invention, for assets to flow internally among network actors so that the network resource asymmetries are automatically regulated.

With embodiments, the blockchain network system is capable of automatically balancing itself, directly among network actors.

Embodiments enable a value flow mechanism to balance asymmetric contributions in blockchain-based platforms.

Embodiments enable to compensate blockchain network actors which are net contributors without requiring any involvement of the service provider.

Embodiments enable to implement an automatic asset distribution mechanism among blockchain actors via a blockchain ledger.

Embodiments enable building smart contracts of blockchain technologies capable of balancing asymmetric contributions of several different types of actors of a blockchain network.

Embodiments provide an efficient solution to the problem of balancing asymmetric contributions of the several actors of a blockchain network for tracking and tracing within a supply chain.

Embodiments provide a transparent compensation mechanism attracting contributor types of actors to participate to a blockchain network associated with a product lifecycle.

Other features which are considered as characteristic for the invention are set forth in the appended claims.

Although the invention is illustrated and described herein as embodied in a method and system for automatically distributing asset pool shares among actors in a blockchain network, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE FIGURE

The sole FIGURE of the drawing is a flowchart schematically illustrating a method for automatically distributing asset pool shares among actors in a blockchain network in accordance with the invention.

### DETAILED DESCRIPTION OF THE INVENTION

Referring now to the sole FIGURE of the drawing in detail, there is shown a flowchart 100 that illustrates embodiments of the invention.

A blockchain network is provided to record transactions of N actors a₁, aᵢ, a_{N} of a supply chain is provided.

At step 101, a contribution parameter is defined for each actor aᵢ, based on an amount of actor data inflow to the network.

At step 102, an obtainment parameter is defined for each actor aᵢ, based on an amount of actor data outflow out of the network.

At step 103, measured values of contribution parameters and measured values of obtainment parameters are received of all the network actors, in a given time interval. The given time interval refers to the time interval in which such parameter values are measured.

At step 104, for each actor aᵢ, an actor contribution ratio Rⁱ_{C} is determined based on a ratio between the own contribution parameter and a sum of all contribution parameters of all N actors.

At step 105, for each actor aᵢ, an actor obtainment ratio Rⁱ_{O} is determined based on a ratio between the own obtainment parameter and a sum of all contribution parameters of all N actors.

At step 106, for each actor aᵢ, a net asset balance NBⁱ is determined based on a product between an asset pool to be distributed among actors and the difference between the contribution ratio and the obtainment ratio.

At step 107, at defined time points, asset pool shares are distributed among the actors by transferring asset amounts directly between actor pairs through a plurality of corresponding blockchain transferal transactions. In at least one transaction, a first actor receives an amount of assets from a second actor having a higher net balance, where asset amounts are determined according to a predefined distribution rule based on the determined net-balances NB₁, NBᵢ, NB_{N} of the N actors.

In an embodiment of the invention, the contribution parameter and the obtainment parameter are measured by measuring respectively volume of actor write data and volume of actor read data via a corresponding smart contract API having as input the actor's network identifier and the given time interval.

The contribution and obtainment parameters, being based on amount of data inflow and outflow to/from the networks, are characteristics of the blockchain ledger so that, in embodiments, a predefined smart contract can perform calculation by reading raw data from the primary blockchain ledger and writing the output transactions into a block on the blockchain ledger.

In embodiments, the transactions for distribution of the asset pool shares may be handled by the same blockchain, herein also called primary blockchain.

In other embodiments, the transactions for distribution of the asset pool shares may be handled by a second blockchain having most of the actors and of the primary blockchain.

Advantageously, asset distribution transactions are recorded in a separate ledger than the ledger that is used for recording the transactions of the primary track and trace blockchain. This optional configuration advantageously provides a separation of traceability and asset transactions.

A plurality of corresponding blockchain transferal transactions are recorded in a ledger acting as a virtual balance sheet.

In an exemplary embodiment, actor read/write data quantities may be used as value flow metrics of exchanged resource contribution to dynamically determine the amount of assets or tokens to be distributed among actors via corresponding blockchain smart contracts.

In an exemplary embodiment, the latest agreed version of the asset distribution rules may be advantageously signed by each actor and stored immutably in the blockchain ledger. Advantageously, asset distribution rules are transparently exposed to each actor, so that each actor can regularly check its contribution/obtainment and its own net balances on corresponding block ledgers.

Examples of read/write data amounts to be measured in a time interval may include, but not limited by, amounts of exchanged data, amount of exchanged data packets, amount of read/write data blocks, amount of read/write operations, amount of read/write transactions, any mix thereof or any quantitative measure of data flow.

In a given embodiment, actors may agree on a predefined set of transaction types. When the actors agree on a predefined set of transaction types (e.g. material movement, quality result, change of ownership), an agreed data-flow unit is set for each type. This conveniently take into account that each transaction may have a same data volume, but may reflect different contribution efforts, for example IOT transaction contributions of a farmer vs transaction contributions of a retailer.

The total data for an actor may be the product of the number of transactions and the corresponding unit values.

The total volume of read and written data by each actor may preferably be tracked by using a blockchain API (“Application Program Interface”) knowing the actor named for each read and write. Advantageously, analytics applications, such as, for example, Mendix of Siemens Industry Software company, may enable data volume tracking of each user.

In an embodiment of the invention, data flow amounts are measured by detecting inserts and queries to the blockchain containing a data flow by calculating their data flow by parsing it to the smart contract.

In other embodiments, where data flow is occurring in the cloud and not in the blockchain, the data flow is measured by making a connector to the exchanged data amount in the cloud.

In yet other embodiments, data stored off-chain may be linked to the blockchain with a single transaction that declares the total volume of the remote data (“VRD”). In these cases, the standard contribution calculation includes a factor representing VRD.

As used herein the terms “asset pool” denote an amount of assets to be distributed among actors in corresponding asset shares to be determined. The asset pool size may be predetermined on a given time interval. In other embodiments, the asset pool size may vary over time according to predefined criteria. In a certain embodiment, the asset pool size may be dynamically set to depend on the level of imbalance between the actors on a given period of time.

In an embodiment, the asset pool may be seen as being virtually replenished by the net benefactors and being virtually emptied by the contributors at each specific time interval.

In embodiments, an intervening balance is held at zero, conveniently avoiding the need to perform any intermediate redistribution actions if the list of actors changes during a time interval.

### Description of an Exemplary Embodiment

Assume that N actors aᵢ of a supply chain participate in a blockchain network and that exchanged resource contributions are measured as data flows and assume that assets are tokens.

The exemplary embodiment for automatically distributing token pool shares among actors includes the following three main phases:

a) value flow measuring;

b) value balancing through token distribution; and

c) token invoicing.

Actor value flows or resource flows are determined by measuring actor contribution parameters and actor obtainment parameters.

In this exemplary embodiment, value flow or resource flow are conveniently measured as data flow from/to the actors to/from the network system.

Accordingly, in embodiments, the contribution parameter of an actor in terms of network system value or network resource may preferably be defined as volume of the data inflow from the actor into the blockchain network in a chosen time interval.

Accordingly, in embodiments, the obtainment parameter of an actor in term of network system value or network resource may preferably be defined as volume of data outflow from the blockchain network to the actor in the chosen time interval.

In embodiments, the net transaction volume is employed as a parameter indicating whether an actor is inserting or extracting value or resources to/from the system: data flowing into the blockchain network are seen as actor contribution to the value or resources of the system; data flowing out of the blockchain network are seen as delivering value or resources from the system.

Assume that the chosen time interval for value flow measuring is a month. On a monthly basis, for each actor aᵢ, the write data volume VOL_{W}ⁱ and the read data volume VOLⁱ_{R} are measured.

The actor write/read data volume is measured for determining the actor net token balance to be distributed for value balancing purposes. The actor net token balance are shares of a predefined token pool AP to be distributed among actors in a peer-to-peer manner.

For each actor, on a monthly basis, a write index I_{W}^{j} is determined as a ratio between the actor's monthly write volume and the sum of all N actor write volumes as shown in formula (f1) below. In other embodiments, weighted sums may conveniently be used.

I_{W}^{j}=(VOL_{W}^{j}/ΣVOL_{W}^{j}) (f1)

For each actor, on a monthly basis, a read index I_{R}^{j} is determined as a ratio between the actor monthly read volume and the sum of all N actor read volumes as shown in formula (f2) below. In other embodiments, weighted sums may conveniently be used.

I_{R}^{j}=(VOL_{R}^{j}/ΣVOL_{R}^{j}) (f2)

For each actor, a net token balance NB^{j} is determined as a product between the token pool AP to be distributed and the difference between the contribution index I_{W}^{j} and the obtainment index I_{R}^{j} as shown in formula (f3) below. In other embodiments, weighted sums may conveniently be used.

NB^{j}=(I_{W}^{j}−I_{R}^{j})*AP=I_{W}^{j}*AP−I_{R}^{j}*AP (f3)

In a simplified numerical example, assume that a blockchain network has the three following participants: actor A, actor B, and actor C, respectively a brand owner, a farmer, and a logistics provider. Assume a token pool value AP is predefined to be 30,000 tokens. In this example, the brand owner A extracts the most value from the system and has therefore agreed to redistribute a rebalance fund of 30,000 tokens.

During month M1, read/write data volumes VOL_{R}^{j}/VOL_{R}^{j} of each actor are measured and recorded the first two rows of Table 1a.

Write/read indexes of all actors are then calculated with formulas (f1) and (f2) and stored in the third and fourth rows of Table 1a.

An actor has a “benefactor” status when its read index is greater than its write index, while an actor has a “contributor” status when its write index is greater than its read index.

Therefore, according to the values determined in Table 1a, actor A is a benefactor and actors B, C are contributors.

In the last row of Table 1a are shown the net token balances calculated with formula (f3): actor A needs to transfer 11.153 tokens, while actor B and C needs to receive respectively 7'624 and 3'529 Tokens.

TABLE 1a
net token balance calculations based
on read/write volumes for month M1.

| | | Actor A | Actor B | Actor C |
|---|---|---|---|---|
| Read | VOL_{R}ⁱ | 600 | 25 | 0 |
| Volume | | | | |
| Write | VOL_{W}ⁱ | 1000 | 500 | 200 |
| Volume | | | | |
| Read | I_{R}ⁱ | 96% | 4% | 0 |
| Index | | | | |
| Write | I_{W}ⁱ | 59% | 29% | 12% |
| Index | | | | |
| Net Token | NBⁱ | −11,153 Tokens | 7,624 Tokens | 3,529 Tokens |
| Balance | | | | |

Based on the results of Table 1a, a corresponding balance sheet for month M1 is determined and shown in Table 1b below.

Table 1b is a result of one of the predefined distribution rules for transferring the determined asset amount between actor pairs, i.e. actor A transfers 11,153 tokens in corresponding shares of 7,624 and 3,529 to actor B and actor C respectively.

According to this embodiment of the distribution rule, in the case of three actors, if there is one benefactor and two contributors, the contributor transfers to each benefactor its due token balance and if there are two benefactors and one contributor, both contributors transfer their due net balance to the only contributor.

It will be understood that other algorithm embodiments of distribution rules for asset transferals are possible with three or more actors, with several different combinations among participating actors and with implementations where amounts to be transferred are divided in smaller portions.

TABLE 1b
token transferal between actor pairs in month M1

| | |
|---|---|
| Transferal from A to B | 7,624 Tokens |
| Transferal from B to A | — |
| Transferal from A to C | 3,529 Tokens |
| Transferal from C to A | — |
| Transferal from B to C | — |

Table 1 b shows a balance sheet of asset distribution among the three actors for month M1.

In another month M2, with different measured read/write volumes, the corresponding read/write index and net balances are determined and shown in Table 2a below.

TABLE 2a
actor net balance calculations based
on read/write volumes for month M2

| | | Actor A | Actor B | Actor C |
|---|---|---|---|---|
| Read | VOL_{R}ⁱ | 600 | 500 | 0 |
| Volume | | | | |
| Write | VOL_{W}ⁱ | 1000 | 500 | 200 |
| Volume | | | | |
| Read | I_{R}ⁱ | 55% | 45% | 0 |
| Index | | | | |
| Write | I_{W}ⁱ | 59% | 29% | 12% |
| Index | | | | |
| Net | NBⁱ | 1,283 Tokens | −4,813 Tokens | 3,530 Tokens |
| Balance | | | | |

Based on calculation of Table 2aᵢ a corresponding balance sheet for month M2 is determined and shown in Table 2b below. Table 2b shows the token transferal amount by using the same token transferal algorithm embodiment as above, where then only benefactor, actor B, transfers its 4'813 tokens in corresponding shares of 1'283 and 3'530 to actor A and actor C respectively.

TABLE 2b
asset transferal between actor pairs in month M2

| | |
|---|---|
| Transferal from A to B | — |
| Transferal from B to A | 1,283 Tokens |
| Transferal from A to C | — |
| Transferal from C to A | — |
| Transferal from B to C | 3,530 Tokens |
| Transferal from C to B | — |

In embodiments, each actor may transfer on a monthly basis an agreed amount of tokens to the service provider, also known as monthly subscription. For example, actors A, B, C may transfer each month 20'000, 7'000, 7'000 tokens respectively.

TABLE 1c
token transferals for month M1

| | Actor A | Actor B | Actor C |
|---|---|---|---|
| Fixed monthly | 20,000 Tokens | 7,000 Tokens | 7,000 Tokens |
| transferal to | | | |
| service provider | | | |
| Net token balance | −11,153 Tokens | 7,624 Tokens | 3,529 Tokens |
| Total monthly | 31,153 Tokens | −624 Tokens | 3,471 Tokens |
| balance for | | | |
| month M1 | | | |

TABLE 2c
token transferals for month M2

| | Actor A | Actor B | Actor C |
|---|---|---|---|
| Monthly subscription | 20,000 Tokens | 7,000 Tokens | 7,000 Tokens |
| Net token balance | 1,283 Tokens | −4,813 Tokens | 3,530 Tokens |
| Total monthly balance | 18,717 Tokens | 11,813 Tokens | 3,471 Tokens |

In embodiments, the monthly net token balance transferals are recorded as virtual balance sheets in ledger blocks of the primary blockchain.

In other embodiments, the monthly net token balance transferals are recorded as virtual balance sheets in ledger blocks via smart contract of a second blockchain.

The first row of Tables 1c and 2c shows the usually fixed monthly subscription transferred by each actor to the service provider.

The second row of Tables 1c and 2c shows the net token balance dynamically transferred directly between actor pairs in a peer-to-peer manner, for the examples with the transferal algorithms of Table 1b and 1c.

The third row of Tables 1c and 2c shows the total monthly balance for each actor, which is the difference between the monthly subscription of the first row and the net token balance of the second row. For example, in month M1, actor B receives 624 tokens due to its contribution to the network resource.

Advantageously, embodiments enable to split between the regular fixed token transferals from the actors to the service provider and the monthly dynamic token transferals among actor pairs. Thus, the monthly subscriptions are independent from the peer-to-peer net balance transferals.

In fact, it is noted that in Tables 1c and 2c, the sum of total monthly balance is equal to the sum of monthly subscriptions, both are 34,000 tokens, and therefore the total revenue flowing from the actors to the service operator is not affected by the size of the agreed token pool.

In embodiments, the monthly subscription may advantageously be paid regularly by each actor to the service provider and the service provider is not involved in the net balance transferal occurring directly among actors.

In embodiments, each month, the smart contracts issue appropriate invoices directly between actors without involving the service provider, ensuring that the net contributors to the system are compensated.

Embodiments enable to employ blockchain platforms which support cryptographic tokens in order to automate the transferal of an automatically determined amount of tokens without reliance on any third party.

In embodiments, actors of a traceability consortium transfer in a peer-to-peer manner an amount of tokens determined in a dynamic manner.

The exemplary embodiment has been described with a number of actors equal to three and with time interval and points of time chosen on a monthly basis. It will be understood by those of skill in the art that embodiments of the invention may apply to any number of actors and with time intervals and/or points in time that are differently selected.

In embodiments, other time intervals may be used for determining the net balances, for example, daily, weekly, and/or other points in time may be used for transferring the token amounts, for example, monthly or bi-annually. For example, data volumes may be measured on a weekly basis (time interval) and then the transferals may be done bi-annually (points in time).

In accordance with an exemplary embodiment of the invention, a system may comprise at least a processor and a memory and receive a request for a transaction or action for a product or an item. The system is typically connected to other devices or systems in order to form a network for exchanging information with respect to the lifecycle of the product or the item.

Examples of transactions or actions include, but are not limited to, a movement of the product or the item from a supplier to a given retailer, an action applied to the product, such as its mixture with another product, or its heating within a specific range of temperatures, a movement of an item, a transferal of a token etc.

In an embodiment of the invention, a system for recording transactions on a distributed network may comprise one or more of the following:
a distributed network to which a proposed transaction is submitted;
a device for cryptographically hashing the submitted transactions based on a cryptographic algorithm; and
another device for verifying the hashed transaction; and
one or more repository for recording the verified transaction.

In an exemplary embodiments, the method may further conveniently include one or more of the following steps:
recording a transaction on a distributed network;
submitting a transaction to a distributed network;
providing a cryptographic algorithm to hash a submitted transaction;
cryptographically hashing a transaction based on the provided algorithm;
verifying the hashed transactions;
recording a verified transaction in one or more repository.

Access to the blockchain network may be provided in the form of software as a service (“SaaS”).

1. A method for automatically distributing asset pool shares among actors in a blockchain network, the blockchain network being configured to record transactions of N actors in a supply chain, the method comprising the following method steps:
a) defining for each actor aᵢ a contribution parameter based on an amount of actor data inflow to the network;
b) defining for each actor aᵢ an obtainment parameter based on an amount of actor data outflow out of the network;
c) receiving measured values of contribution parameters and measured values of obtainment parameters of the N actors in a given time interval;
d) for each actor aᵢ, determining an actor contribution ratio Rⁱ_{C} based on a ratio between an own contribution parameter associated with the respective actor aᵢ and a sum of all contribution parameters of all N actors;
e) for each actor aᵢ, determining an actor obtainment ratio Rⁱ_{O} based on a ratio between the own obtainment parameter and a sum of all contribution parameters of the N actors;
f) for each actor aᵢ, determining a net asset balance NBⁱ based on a product between an asset pool to be distributed among actors and a difference between the contribution ratio and the obtainment ratio;
g) at defined points in time, distributing asset pool shares among the actors by transferring asset amounts directly between actor pairs through a plurality of corresponding blockchain transferal transactions in which, in at least one transferal transaction, a first actor receives an amount of assets from a second actor having a higher net balance, where the amounts of assets amounts are determined according to a predefined distribution rule based on the net asset balances NB¹, NB^{j}, NB^{N} of the N actors.

2. The method according to claim 1, wherein step c) comprises measuring the contribution parameter and the obtainment parameter by measuring respectively a volume of actor write data and a volume of actor read data via a corresponding smart contract API having as input the respective actor's network identifier and the given time interval.

3. The method according to claim 1, which comprises distributing the asset pool shares by the same blockchain.

4. The method according to claim 1, which comprises distributing the asset pool shares by an additional, separate blockchain.

5. A data processing system for automatically distributing asset pool shares among actors in a blockchain network, the data processing system comprising:
a processor and an accessible memory, and the data processing system being configured to execute the method steps according to claim 1.
